(19) United States
(12) Patent Application Publication
(10) Pub. No.: US 2023/0417305 A1
(43) Pub. Date: Dec. 28, 2023

(54) TRANSMISSION MECHANISM

(71) Applicant: AITRONIX CORPORATION, Hyogo (JP)

(72) Inventor: Ichiro FUJIMOTO, Hyogo (JP)

(73) Assignee: AITRONIX CORPORATION, Hyogo (JP)

(21) Appl. No.: 18/460,672

(22) Filed: Sep. 4, 2023

Related U.S. Application Data
(63) Continuation of application No. PCT/JP2021/009874, filed on Mar. 11, 2021.

(51) Int. Cl. F16H 9/24; F16H 55/54

(52) U.S. Cl. CPC F16H 9/24; F16H 55/54

(57) ABSTRACT

In a transmission mechanism (1A) having a main shaft, first and second disk sets (7A, 7B) each having first and second disks (10A, 11A, 10B, 11B) arranged in close proximity to and perpendicular to the main shaft, and a composite transmission wheel (S) including transmission wheels (18) comprising sprockets or pinions and guide rods (9), and configured to change speed by changing the radius of the composite transmission wheel (S), at least one clutch mechanism (21, 22) capable of switching each transmission wheel (18) between a rotation inhibited state and a rotation permitted state is provided, and via the clutch mechanism (21,22), each transmission wheel (18) is allowed to rotate during speed change operation and is prohibited from rotating during other than speed change operation.

### CROSS-REFERENCE TO RELATED APPLICATION

This application is a continuation of the International PCT application serial no. PCT/JP2021/009874, filed on Mar. 11, 2021. The entirety of the above mentioned patent application is hereby incorporated by reference herein and made a part of this specification.

### TECHNICAL FIELD

The present invention relates to a transmission mechanism in which small diameter sprockets are arranged circumferentially, both ends of the sprocket's shafts are supported at intersections of radial slits formed in first and second disks adjacent to each other, respectively, and the radius of the combined sprocket is changed by changing the rotation phase of the second disk relative to the first disk.

### BACKGROUND ART

In Patent Document #1, disclosed is a stepless transmission mechanism having a main shaft, first and second disk sets each having first and second disks arranged orthogonally and proximally to the main shaft, a plurality of first and second radial slits formed on the first and second disks respectively, and three sprockets and six guide rods supported at intersections of the first and second radial slits in the first and second disk sets. This stepless transmission mechanism is configured to change a radius of a combined sprocket that includes three sprockets and six guide rods by changing a rotation phase of the second disk with respect to the first disk.

Since the sprockets are prohibited from rotation even during speed change operation, a phase of the sprockets does not match that of a chain during speed changing. Therefore, a mechanical rotation drive mechanism is provided to set a rotation phase of the sprockets during speed change operation. In this rotation drive mechanism, pinions are fixed to shaft ends of two of the three sprockets respectively, and a rack member is provided along paths of radial moving of the pinions to set the rotation phase of the sprockets via the rack and pinion mechanism when the sprockets move in the radial direction during speed changing. However, the two pinions are set to rotate in opposite directions.

Patent Document #2 discloses a transmission mechanism similar to the stepless transmission mechanism of Patent Document #1, which having sector gear members and support portions for supporting the sector gear members instead of sprockets. In this stepless transmission mechanism, a free movement permitting mechanism is provided to allow the sector gear members to move freely within a predetermined range with respect to the support portions, and the sector gear members are pressured toward a reference phase by gear biasing members.

In a stepless transmission described in Patent Document #3, a plurality of slide members which can move radially along a plurality of radial grooves formed in a pair of disks are provided, sprockets are attached to the slide members, and screw rods are screwed into female screw holes of the slide members. To move the plurality of slide members in the radial direction, a power distribution mechanism is provided to rotate and drive the screw rods simultaneously, and each sprocket is equipped with a reverse rotation prevention mechanism such as a one-way clutch that allows rotation in one direction only.

### PRIOR ART DOCUMENTS

### Patent Documents

Patent Document #1: JP-A-2015-178874.
Patent Document #2: WO2017/094404.
Patent Document #3: JP-A-2002-250420.

### SUMMARY OF THE INVENTION

### Problems to be Solved by the Invention

In the transmission mechanism disclosed in Patent Document #1, the rotation of the sprockets is prohibited even during the speed change operation, so the mechanical rotation drive mechanism is provided to set the rotation phase of the sprockets during speed change operation.

However, since this rotation drive mechanism has a structure in which the two sprockets are rotated in opposite directions, it not only exerts tension or compression on the chain, but one of the sprockets rotates in the direction opposite to the moving direction of the chain, a large shift operation force is required, and the speed change operation mechanism becomes large.

In the free movement permitting mechanism of Patent Document #2, an allowable range of the phase difference of the sector gear members cannot be increased and is the minimum necessary, so that a large speed change cannot be performed when the rotation is stopped. Therefore, it becomes difficult to deal with an abnormality in the power source side or the output side.

In addition, when a load torque is applied, a large force is required for speed change operation, which degrades efficiency and also requires a force to maintain a speed change ratio.

And, because the sector gear members are not in phase at the moment when the chain and the sector gear members are meshed, a lot of collision noise is always generated.

In the stepless transmission of Patent Document #3, the one-way clutch is used to enable speed changing, and a fixed clutch is used to handle reverse rotation and engine braking. Therefore, it is not possible to perform speed change operation during reverse rotation and engine braking. Moreover, Patent Document #3 does not disclose any specific structure of the clutch.

An object of the present invention is to provide a transmission mechanism that enables a phase of transmission wheels with respect to a chain or toothed belt to be adapted by allowing the transmission wheels to rotate during speed change operation, and another object of the present invention is to provide a transmission mechanism with a locking mechanism that firmly locks the transmission wheels so that it does not move in the radial direction when not performing speed change operation.

### Means to Solve the Problems

The present invention presents a transmission mechanism comprising a main shaft, first and second disk sets mounted on the main shaft in a spaced apart and facing manner each having first and second disks mounted on the main shaft in close proximity perpendicular to the main shaft, a plurality of first and second radial slits formed in the first and second disks respectively, and a plurality of transmission wheels formed by a plurality of sprockets or pinions supported at intersections of the first and second radial slits in the first and second disk sets and a plurality of guide rods, and a composite transmission wheel for engaging with a driving force transmission chain or toothed belt is configured with the plurality of transmission wheels and the plurality of the guide rods; wherein each of transmission wheels is provided with at least one clutch mechanism capable of switching the transmission wheel between a rotation prohibited state and a rotation permitted state, through the clutch mechanism, each transmission wheel is put in the rotation permitted state during speed change operation, and is put in the rotation prohibited state during other than speed change operation.

According to the above configuration, since each transmission wheel is allowed to rotate on its own axis during speed change operation, when sprockets are employed as transmission wheels, the phase of the sprockets is adapted to the chain, and the allowable range of phase is infinite within the speed change range, so that various predetermined speed change ratios can be applicable even when rotation is stopped. At the moment of speed change operation, the sprockets are not in phase, but when they are in various predetermined speed change ratios, they are in phase, so that the collision noise between the sprockets and the chain is reduced.

Moreover, since the load torque is interrupted during gear shifting, gear shifting can be performed with a small force, and gear shifting can be performed not only during forward rotation of the transmission mechanism, but also during reverse rotation or under a reverse load state.

Moreover, the load torque is intercepted during speed change operation, so that speed change can be performed with a small force, and speed change operation is possible not only during forward rotation of the transmission mechanism, but also during reverse rotation and reverse load conditions. And, since each transmission wheel is put in a rotation-prohibited state during other than speed change operation, torque can be transmitted through the composite transmission wheel.

The present invention can also adopt various preferred configurations shown below.

The first configurations has a phase change mechanism capable of changing the rotation phase of the second disk with respect to the first disk in the first and second disk sets during speed change operation.

The second configurations has a disk moving mechanism capable of moving at least one of the first disks of the first disk set and the second disk set on the side of the clutch mechanism by a predetermined distance in a direction in which the transmission wheel is allowed to rotate during speed change operation.

In a third configurations, at least one clutch mechanism includes first and second dog clutch mechanisms provided on both sides of the transmission wheel.

In the fourth configurations, one of the first and second dog clutch mechanisms is in a half-clutched state during speed change operation, and the transmission wheels are put in the rotation prohibited state during other than speed change operation.

In the fifth configurations, first rack teeth are formed near the first radial slits into which the support shafts are inserted in the pair of the first disks of the first and second disk sets, further comprising a first locking mechanism that locks the transmission wheels in cooperation with the first rack teeth so that the transmission wheels cannot move in the radial direction of the first disk during other than speed change operation, and allows the transmission wheels to move in the radial direction of the first disk during speed change operation.

In the sixth configurations, second rack teeth are formed near the first radial slits into which the guide rods are inserted in the pair of the first disks of the first and second disk sets, further comprising a second locking mechanism that locks the guide rods in cooperation with the second rack teeth so that the guide rods cannot move in the radial direction during other than speed change operation, and allows the guide rods to move in the radial direction during speed change operation.

In the seventh configurations, gear teeth are formed on an outer circumference of the first disk of at least one of the first and second disk sets, and a gear member for driving force input or driving force output that meshes with the gear teeth is provided.

In an eighth configurations, said at least one clutch mechanism includes first and second splined clutch mechanisms provided on opposite sides of the transmission wheel.

In a ninth configurations, the transmission wheel is the sprockets, and when changing the radius of the composite sprocket via the phase change mechanism during speed change operation, the radius is set so that an outer circumference length of the composite sprocket is an integral multiple of a link pitch of the driving force transmission chain.

In the tenth configurations, the transmission wheel is the sprocket, and when setting the radius of the composite transmission wheel during speed change operation, the sprockets are set to a sprocket phase such that the outer circumference length of the composite transmission wheel is an integral multiple of a link pitch of the driving force transmission chain and the sprockets are put in the rotation prohibited state.

In an eleventh configurations, the transmission wheel is the sprocket, and when setting the radius of the composite transmission wheel during speed change operation, the clutch mechanism which is in a half-clutched state, makes sprockets to have a phase of the sprockets such that the outer circumference length of the composite transmission wheel is an integral multiple of a link pitch of the driving force transmission chain.

### Advantages of the Invention

According to the present invention, various effects as described above can be obtained.

### BRIEF DESCRIPTION OF THE DRAWINGS

FIG. 1 is a perspective view of a transmission for a first embodiment of the present invention;

FIG. 2 is a perspective view of the transmission shown in FIG. 1;

FIG. 3 is a perspective view of a main part of a tensioner mechanism;

FIG. 4 is a perspective view of the transmission mechanism;

FIG. 5 is a front view of the transmission mechanism;

FIG. 6 is a plan view of the transmission mechanism;

FIG. 7 is a side view of the transmission mechanism;

FIG. 8 is a cross-sectional view taken along line VIII-VIII of FIG. 6;

FIG. 9 is a cross-sectional view taken along line IX-IX of FIG. 6;

FIG. 10 is an exploded perspective view of a main part of the transmission mechanism;

FIG. 11 is a diagram of a disk movement mechanism and a phase change mechanism of the transmission mechanism;

FIG. 12 is a perspective view of a sprocket unit:

FIG. 13 is a front view of the sprocket unit;

FIG. 14 is a perspective view of the sprocket unit:

FIG. 15 is a view in the direction of arrow XV of FIG. 14;

FIG. 16 is a cross-sectional view taken along line XVI-XVI of FIG. 15;

FIG. 17 is a perspective view of a guide rod;

FIG. 18 is a cross-sectional view taken along line XVIII-XVIII of FIG. 17;

FIG. 19 is perspective view of a main part of a transmission mechanism for a second embodiment;

FIG. 20 is a perspective view of a sprocket unit;

FIG. 21 is a plan view of the sprocket unit;

FIG. 22 is a view in the direction of arrow XXII of FIG. 21.

FIG. 23 is an exploded perspective view of half of the sprocket unit;

FIG. 24 is a perspective view of a guide rod;

FIG. 25 is an exploded view of the first disk:

FIG. 26 is a cross-sectional view of a main part of the transmission mechanism when the sprocket unit is in a connected state;

FIG. 27 is a cross-sectional view of the main part of the transmission mechanism when the sprocket unit is in a separated state.

### DESCRIPTION OF EMBODIMENTS

Best mode for implementing the present invention will now be explained on basis of embodiments.

### First Embodiment

First Embodiment of the present invention will be described below with reference to figures.

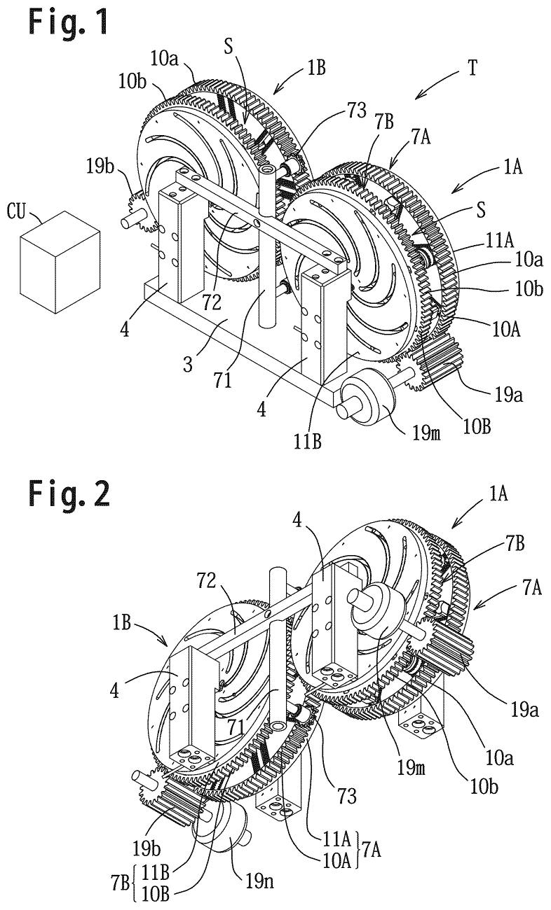

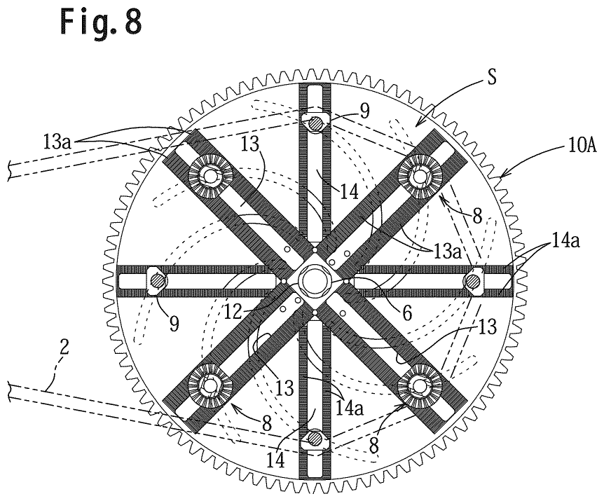

As shown in FIGS. 1 and 2, the transmission T is provided with two sets of transmission mechanisms 1A, 1B having the same structure, and a driving force transmission chain 2 for transmitting driving force (see FIG. 8) is crossed over these transmission mechanisms 1A, 1B to input driving force to one transmission mechanism 1A and output driving force from the other transmission mechanism 1B. Either a roller chain or a silent chain can be used as the driving force transmission chain 2.

Next, the transmission mechanism 1A will be described.

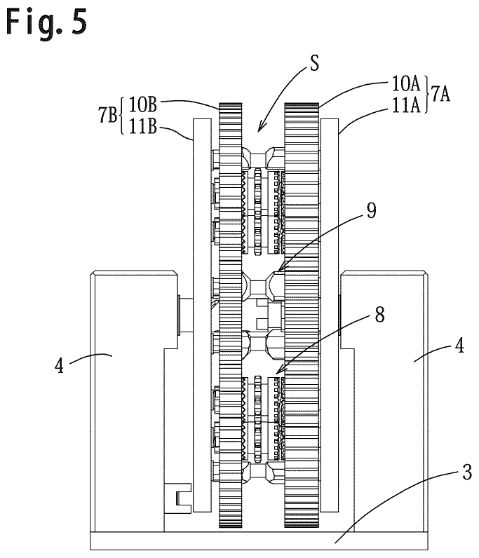

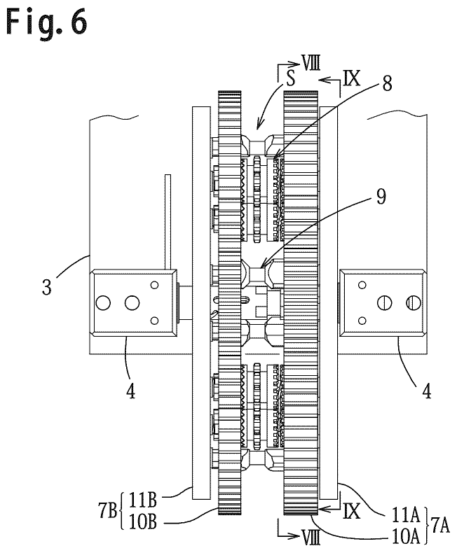

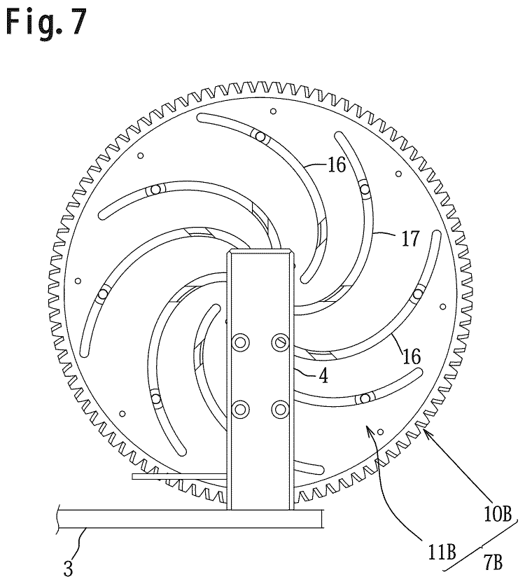

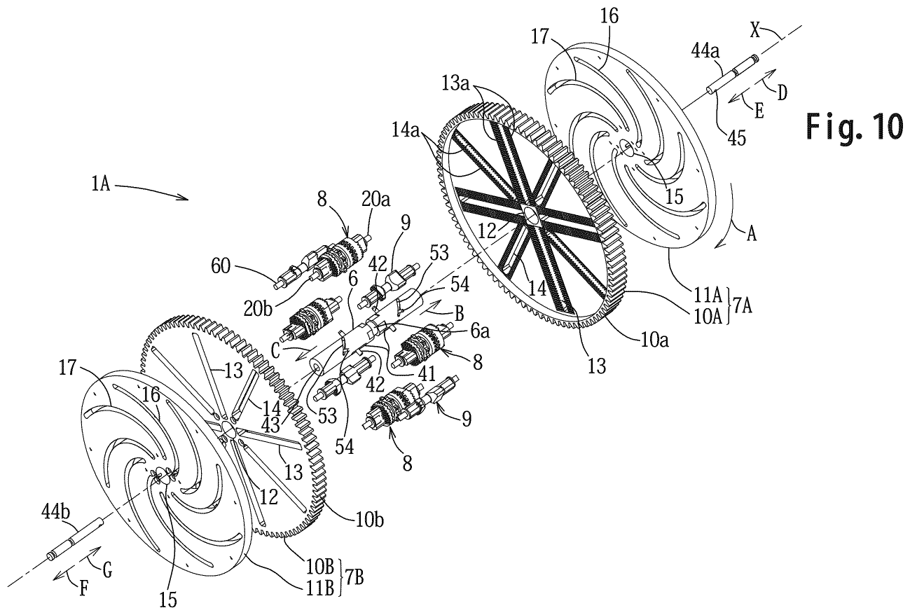

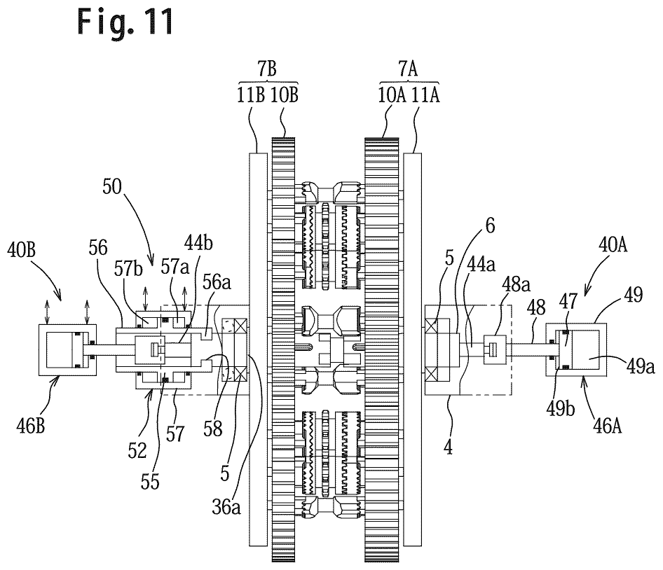

As shown in FIGS. 4 to 10, the transmission mechanism 1A has a base 3, a pair of support columns 4 standing on the base 3, a main shaft 6 supported at both ends by these support columns 4 via bearings 5 (see FIG. 11), first and second disk sets 7A, 7B mounted separately and oppositely on the main shaft 6, four sprocket units 8, and four guide rods 9. In addition, multiple sprocket units 8 of three or more than five may be employed. A plurality of guide rods 9, three or more than five, may be employed. A forward rotation direction of the transmission mechanism 1A is in the direction of arrow A shown in FIG. 10. An axis center of the main shaft 6 is shown as the axis center X in the figure. Sprockets in this embodiment correspond to a transmission wheel, and a composite sprocket corresponds to a composite transmission wheel.

The first and second disk sets 7A, 7B have a circular first disk 10A, 10B and a circular second disk 11A, 11B, respectively, arranged orthogonally and proximally to the main shaft 6. These first disks 10A, 10B are similar, although the width of the first disk 10A in the axis center X direction is slightly larger than the width of the first disk 10B in the axis center direction.

A pair of first disks 10A, 10B are arranged facing each other on the sprocket units 8 side, and a pair of second disks 11A, 11B are arranged on opposite sides of the sprocket unit 8 with respect to the first disk 10. The axis center X of the main shaft 6, the axis centers of the first disks 10A, 10B, and the axis centers of the second disks 11A, 11B are concentric. The first disks 10A, 10B are mounted non-rotatably and movably in the direction of the axis center X with respect to the main shaft 6, and the second disks 11A, 11B are mounted rotatably and non-movably in the direction of the axis center X with respect to the main shaft 6.

In the transmission mechanism 1A, the first disks 10A, 10B are formed slightly larger in diameter than the second disks 11A, 11B. Gear teeth 10a, 10b are formed on outer circumferences of the pair of first disks 10A, 10B, and a driving force input gear 19a is provided that meshes with these gear teeth 10a, 10b, and the driving force is input to this driving force input gear 19a from outside via a clutch mechanism 19m. Incidentally, the diameter of the driving force input gear 19a is appropriately set. The gear teeth may be formed only on one first disk 10A or 10B, so that the driving force is input only to one first disk 10A or 10B.

In the transmission mechanism 1B, gear teeth 10a, 10b are formed on outer circumferences of the first pair of disks 10A and 10B, and a driving force output gear 19b is provided that meshes with these gear teeth 10a, 10b, and the driving force is output from this driving force output gear 19b to the outside through a clutch mechanism 19n. Incidentally, the diameter of the driving force output gear 19b is appropriately set. The gear teeth may be formed only on the first disk 10A or 10B, and the driving force may be output from a single first disk 10A or 10B.

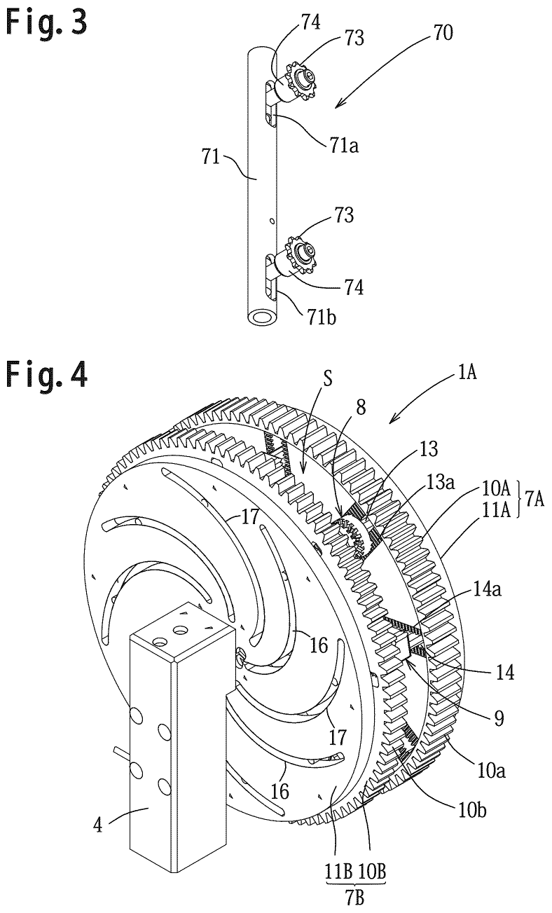

Next, a tensioner mechanism 70 that absorbs slack in the driving force transmission chain 2 will be described. As shown in FIGS. 1 to 3, a pipe member 71 is standing on the base 3 between the support columns 4 on the second disk set 7B side of the transmission mechanisms 1A, 1B, and this pipe member 71 is reinforced by a horizontal reinforcing member 72 bridged over the pair of support columns 4. Long holes 71a, 71b are formed in upper and lower sides of the pipe member 71, a pair of horizontal axis members 74 supporting a pair of upper and lower tensioner sprockets 73 are introduced into the inside through the long holes 71a, 71b and connected to internal movable members. The pair of axis members 74 are pressured toward the side of the phase proximity by tension springs or hydraulic cylinders installed inside the pipe member 71 via the movable members mentioned above.

The tensioner mechanism 70 may be omitted, and instead, as shown in FIG. 1, the left-right position of the transmission mechanism 1B relative to the base 3 may be configured so that the left-right distance between the main shafts 6 of the transmission mechanisms 1A, 1B can be fine-tuned automatically or manually.

As shown in FIGS. 8 to 10, the first disk 10A has a shaft insertion hole 12, four first radial slits 13 corresponding to the four sprocket units 8, and four first radial slits 14 corresponding to the four guide rods 9. The second disk 11A has a shaft insertion hole 15, four second radial slits 16 corresponding to the four sprocket units 8, and four second radial slits 17 corresponding to the four guide rods 9.

The first radial slits 13, 14 are formed into straight radial slits with different 45° directions. On the sprocket units 8 side surface of the first disk 10A, rack teeth 13a, 14a are formed near both sides of the straight radial slits 13, 14. The width of the rack teeth 13a is larger than the width of the rack teeth 14a. The rack teeth 13a and 14a are rectangular teeth having a pointed tip surface in the lateral view. The function of the rack teeth 13a, 14a will be described later.

The second radial slits 16, 17 of the second disk 11A are curved radial slits that intersect the straight radial slits above when viewed from the axis center direction. And these second radial slits 16, 17 are formed as curved radial slits such that the intersection angle with the circumferential direction decreases as it shifts from the axis center X side to the outer circumferential side. In addition, straight radial slits may be used instead of the curved radial slits.

As shown in FIGS. 8 to 10, in each of the four sprocket units 8, one end portion 20a on the first disk set 7A side of a support shaft 20 of the sprocket unit 8 is supported at the intersection of the straight radial slit 13 and curved radial slit 16 in the first disk set 7A, and the other end portion 20b of the support shaft 20 is supported at the intersection of the straight radial slit 13 and the curved radial slit 16 in the second disk set 7B.

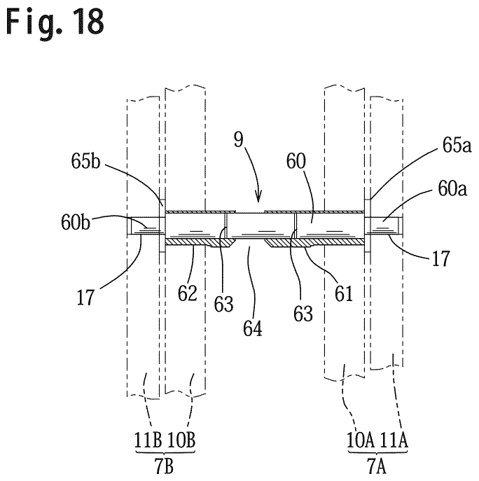

In each of the four guide rods 9, one end portion 60a of a support shaft 60 of the guide rod 9 is supported at the intersection of the first radial slit 14 and the second radial slit 17 of the first disk set 7A, and the other end portion 60b of the support shaft 60 is supported at the intersection of the first radial slit 14 and the second radial slit 17 of the second disk set 7B (see FIG. 18).

A composite sprocket S including the above four sprocket units 8 and the four guide rods 9 is configured to engage with the driving force transmission chain 2 (see FIG. 8). In the first and second disk sets 7A, 7B, the rotation phase of the second disks 11A, 11B relative to the first disks 10A, 10B are changed respectively. As a result, the radial positions of the intersections of the first radial slits 13, 14 and the second radial slits 16, 17 are changed, and the radius of the composite sprocket S is changed to enable speed changes.

In addition, a small diameter portion 6a is formed in the center of the length direction of the main shaft 6 to avoid interference with the teeth of a sprocket 18 when the radius of the composite sprocket S is minimized.

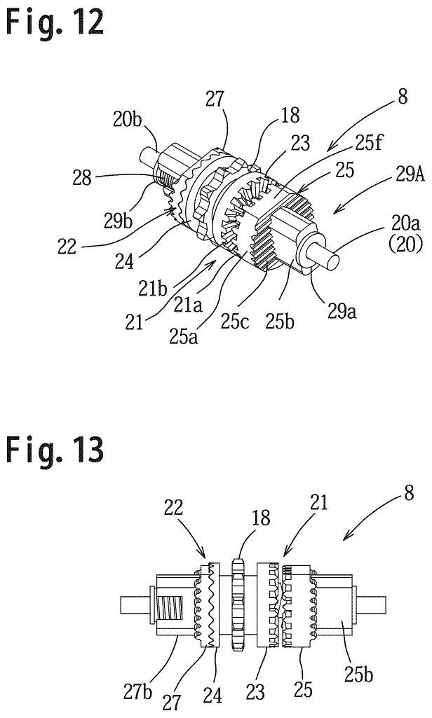

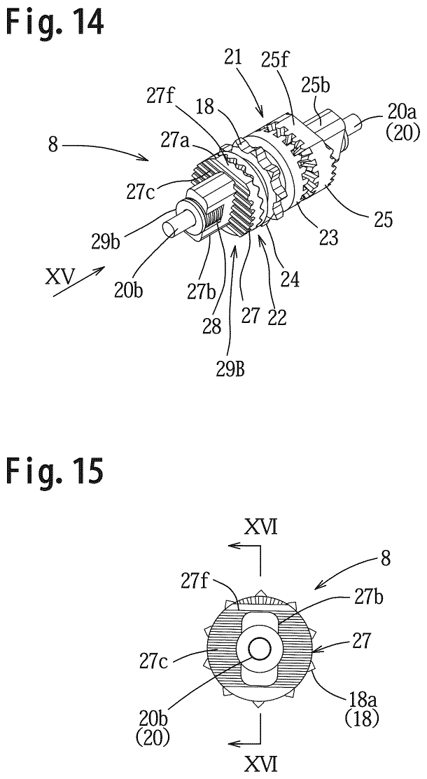

In order to connect and disconnect the four first and second clutch mechanisms 21, 22 (see FIGS. 12 to 16) that switch the operating state of the four sprocket units 8 during speed change operation, as shown in FIG. 11, disk moving mechanisms 40A, 40B are provided that can move the first pair of disks 10A, 10B of the first and second disk sets 7A, 7B in the direction of approaching and separating. In order to change the radius of the composite sprocket S during speed change operation, a phase change mechanism 50 is provided that can change the rotation phase of the second disks 11A, 11B with respect to the first disks 10A, 10B in the first and second disk sets 7A, 7B equally.

Since the disk moving mechanisms 40A, 40B have the same structure, only the disk moving mechanism 40A will be described. As shown in FIGS. 10 and 11, the disk moving mechanism 40A includes flat slits 41 formed through the main shaft 6 and having a predetermined length in the axis center direction, orthogonal pins 42 inserted orthogonally to the flat slits 41 and protruding at both ends outside the surface of the main shaft 6, the two ends of which are connected to an inner circumferential wall of the shaft insertion hole 12 of the first disk 10A. The disk moving mechanism 40A further includes pin installation holes 43 (see FIG. 10), which are formed from the both ends of the main shaft 6 to the axially centered portion and reached the flat slits 41, an operating pin 44a slidably installed in the pin installation hole 43, with an orthogonal pin 42 inserted through a through hole 45 in the tip of the operating pin 44a, and an open/close actuator 46A that drives the operating pin 44a to move in the axis center direction. The disk moving mechanism 40B has an open/close actuator 46B.

When the pair of first discs 10A, 10B are separated by the open/close actuators 46A, 46B when operating speed change, the operating pin 44a is moved by the open/close actuator 46A in the direction of arrow D by about 5 mm, for example, and an operating pin 44b is moved by about 2 mm, for example, in the direction of arrow F by opening/closing actuator 46B. As a result, the first disks 10A, 10B are in the open position, separated from each other.

The opening/closing actuator 46A consists of double action type of hydraulic cylinder. The hydraulic cylinder has a piston rod 48 with a piston portion 47 and a cylinder body 49. A connecting member 48a at the end of the piston rod 48 is rotatably connected to the annular groove at the end of the operating pin 44a.

First and second oil chambers 49a, 49b are formed in the cylinder body 49. When hydraulic pressure is supplied to the first oil chamber 49a and discharged from the second oil chamber 49b, the piston rod 48 moves to the left in FIG. 11. When hydraulic pressure is discharged from the first oil chamber 49a while supplying hydraulic pressure to the second oil chamber 49b, the piston rod 48 moves to the right in FIG. 11. The hydraulic supply source (not shown) that supplies hydraulic pressure to the above hydraulic cylinder 46A has flow control means that can precisely control the flow rate of hydraulic pressure supplied to the hydraulic cylinder 46A. The above hydraulic supply source and flow control means are controlled by the control unit CU. In this document, “hydraulic pressure” means compressed oil.

The connecting member 48a at the end of the piston rod 48a of the hydraulic cylinder 46B of the disk moving mechanism 40B is connected to the operating pin 44b. The above hydraulic cylinders 46A, 46B are examples. Instead of hydraulic cylinders 46A, 46B, a disk moving mechanism that precisely moves and drives the main shaft in the left and right directions by means of an electric motor and gear mechanism can be employed.

As shown in FIGS. 10, 11, the phase change mechanism 50 has a phase change actuator 52 that moves and drives the main shaft 6 in its axis center X direction, and a pair of helix grooves 53 formed symmetrically on the main shaft 6 at one end portion and the other end portion, respectively. The phase change mechanism 50 further has a pair of connecting pins 54, the base of which is fixed to the inner circumferential wall of the shaft insertion hole 15 of the pair of second disks 11A, 11B and the tip of which protrudes toward the main shaft 6 and is engaged in the pair of helix grooves 53. The helix groove 53 is shaped such that when the connecting pin 54 moves in the axis center X direction by 9 mm, for example, the disk 11 rotates by about 90°, for example.

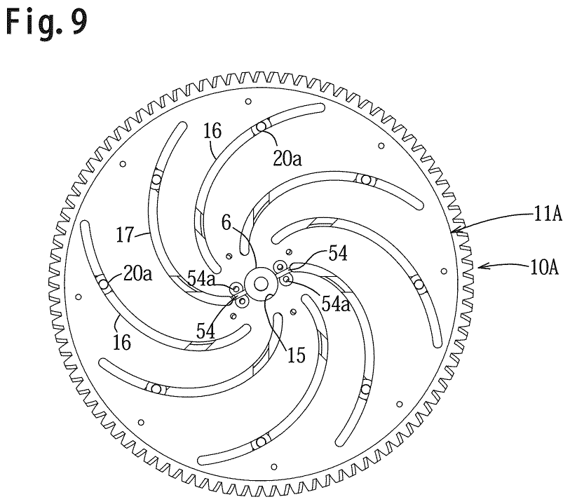

As shown in FIG. 9, the pair of connecting pins 54 are mounted in recessed grooves extending in the radial direction of the second disk 11 and fixed by a pair of screws 54a while engaged in the pair of helical grooves 53.

The phase change actuator 52 consists of a double-action hydraulic cylinder. This hydraulic cylinder has a sleeve-shaped piston rod 56 with an annular piston portion 55 and a cylinder body 57. The base of the piston rod 56 has an annular engagement portion 56a, which is rotatably engaged in the annular groove 58 of the main shaft 6.

Inside the cylinder body 57, first and second oil chambers 57a, 57b are formed on both sides of the annular piston portion 55. When the hydraulic pressure in the second oil chamber 57b is discharged while supplying hydraulic pressure to the first oil chamber 57a, the piston rod 56 and the main shaft 6 move to the left (in the direction of arrow C) in FIGS. 10, 11, and the pair of helix grooves 53 move to the left, so the second disks 11A, 11B rotate in the reverse direction relative to the first disks 10A, 10B and the four sprocket units 8 and the guide rods 9 move to the radius-reducing side.

Contrary to the above, when the hydraulic pressure in the first oil chamber 57a is discharged while supplying hydraulic pressure to the second oil chamber 37b, the piston rod 56 and the main shaft 6 move to the right (in the direction of arrow B) and the pair of helix grooves 53 move to the right (in the direction of arrow B). As a result, the second disks 11A, 11B rotate in the forward direction A with respect to the first disks 10A, 10B, and the four sprocket units 8 and the guide rods 9 move to the radius-expanding side.

The hydraulic supply source (not shown) that supplies hydraulic pressure to the hydraulic cylinder 52 above has flow control means that can precisely control the flow rate of hydraulic pressure supplied to the hydraulic cylinder 52, and the hydraulic supply source and flow control means above are controlled by the control unit CU.

The above 52 hydraulic cylinder is just one example. Instead of hydraulic cylinder 52, an electric motor and gear mechanism can be used to drive the main shaft 6 precisely in the left-right direction.

The sprockets 18 of the sprocket units 8 is in a rotation prohibited state when the sprocket units are not used for speed change operations, and in a rotation allowed state when the sprocket units are used for speed change operations. Therefore, in each of the four sprocket units 8, first and second clutch mechanisms 21, 22 are provided that can engage and disengage both ends of the sprockets 18 in order to switch the operating state of the four sprockets 18 during speed change operations. Then, through the first and second clutch mechanisms 21, 22, the four sprockets 18 are put into the state in which they are allowed to rotate themselves during speed change operation, and the four sprockets 18 are put into the state in which they are prohibited from rotating themselves when speed change operation is completed.

Next, the sprocket unit 8 will be described based on FIGS. 12 to 16.

The first and second clutch mechanisms 21, 22 are each a dog clutch mechanism. The first clutch mechanism 21 has a first annular portion 23 integrally formed on one end of the sprocket 18, a first clutch member 25 mounted on the support shaft 20 opposite the first annular portion 23, a pair of first clutch teeth 21a, 21b formed on opposite annular surfaces of the first annular portion 23 and the first clutch member 25, and a first spring 26 (compression spring) attached to the inner recess of the first annular portion 23 and the first clutch member 25 to force the first clutch member 25 toward the separation side with respect to the sprocket 18.

The first clutch member 25 is always unable to rotate by engaging the engagement convex 25b protruding on the opposite side of the sprocket 18 with the straight radial slit 13 of the first disk 10A in a radially movable and non-rotating manner. As shown in FIG. 15, the sprocket 18 has, for example, 10 sprocket teeth 18a, and the tips of the sprocket teeth 18a are formed in a radially pointed shape. This is to enhance the meshing performance that engages with the driving force transmission chain 2. The first clutch teeth 21a, 21b are rectangular teeth with pointed tips in the lateral view.

The inner diameter side portion of the first clutch member 25 has a chamfer 25f. This is to avoid interference with the main shaft 6 when the radius of the composite sprocket S is minimized. The sprockets 18 and the first clutch member 25 are locked tightly against radial movement when not in speed change operation, and are switched to be movable in the radial direction to change the diameter of the composite sprocket S when in speed change operation. A locking mechanism 29A is provided to accomplish this.

Next, the locking mechanism 29A will be described.

The first clutch member 25 has a disk portion 25a, an engagement convex portion 25b of rectangular cross section protruding from this disk portion 25a toward the opposite side of the sprocket 18, which always engages the straight radial slit 13 to prohibit rotation of the first clutch member 25, and engagement teeth 25c formed on both sides of the engagement convex portion 25b at the end face of the disk portion 25a from which the engagement convex portion 25b protrudes, which can engage and disengage the rack teeth 13a on both sides of the straight radial slit 13. The engagement teeth 25c are rectangular teeth with pointed tips in the lateral view.

When the first disk 10A corresponding to the first clutch member 25 is moved toward the sprockets 18 by the disk moving mechanism 40A, the first clutch mechanism 21 is connected and the sprockets 18 are prohibited from rotating. Then, in the locking mechanism 29A, the engagement teeth 25c of the first clutch member 25 engage the rack teeth 13a of the first disk 10A, and the sprocket unit 8 is in a locked state that prohibits movement in the radial direction. During speed change operation, the locking mechanism 29A is released to allow the sprocket unit 8 to move in the radial direction.

The first clutch mechanism 21 above is an example, and a clutch mechanism other than a dog clutch mechanism that can transmit driving force in both forward and reverse directions can be employed.

The second clutch mechanism 22 has a second annular portion 24 integrally formed on the other end of the sprocket 18, a second clutch member 27 mounted on the support shaft 20 opposite the second annular portion 24, a pair of second clutch teeth 22a, 22b formed on opposite annular surfaces of the second annular portion 24 and the second clutch member 27, a second spring 28 (compression spring) that is attached to the inner recess of the second clutch member 27 and forces the second clutch member 27 toward the sprocket 18 against the support shaft 20.

The second clutch member 27 is always non-rotatable by engaging an engagement convex portion 27b protruding on the opposite side of the sprocket 18 with the straight radial slit 13 of the first disk 10B in a radially movable and non-rotatable manner. The second clutch teeth 22a, 22b are corrugated teeth with a corrugated shape in lateral view.

Between the second annular portion 24 and the second clutch member 27, the support shaft 20 has an annular portion 20c with an enlarged diameter, and the second annular portion 24 of the sprocket 18 is received by the annular portion 20c while the second dog clutch 22 is kept connected, and the second clutch member 27 is also received by the annular portion 20c, with the second clutch teeth 22a, 22b engaged. Instead of the annular portion 20c, a retaining ring may be employed.

A chamfer 27f is formed on the disk portion of the second clutch member 27. This is to avoid interference with the main shaft 6 when the radius of the composite sprocket S is minimized.

The sprocket 18 and the second clutch member 27 are locked tightly so that they do not move in the radial direction when not in speed change operation, and are switched to be able to move in the radial direction to change the diameter of the composite sprocket S during speed change operation. A locking mechanism 29B is provided to accomplish this.

Next, the locking mechanism 29B above will be described.

The second clutch member 27 has a disk portion 27a, an engagement convex portion 27b of rectangular cross section protruding from the disk portion 27a toward the opposite side of the sprocket 18, which always engages the straight radial slit 13 to prohibit rotation of the second clutch member 27, and engagement teeth 27c formed on both sides of the engagement convex portion 27b at the end face of the disk portion 27a from which the engagement convex portion 27b protrudes, which can engage and disengage the rack teeth 13a on both sides of the straight radial slit 13.

When the first disk 10B corresponding to the second clutch member 27 is moved toward the sprocket 18 side by the disk moving mechanism 40B, the second clutch mechanism 22 remains connected. In the locking mechanism 29B, the engagement teeth 27c of the second clutch member 27 engage the rack teeth 13a of the first disk 10B, and the second clutch member 27 is in a locked state that prohibits its movement in the radial direction. During speed change operation, the locking mechanism 29B is released, allowing the sprocket units 8 to move in the radial direction.

Small diameter portions 20a, 20b are formed at both ends of the support shaft 20, and the small diameter portions 20a, 20b are inserted into the curved radial slits 16 of the second disks 11A, 11B on the corresponding side.

Washers 20m, 20n are attached to the sprocket-side ends of these small diameter portions 20a, 20b. The sprocket 18, the first and second annular portions 23, 24, and the first and second clutch members 25, 27 are rotatably mounted on the support shaft 20.

In addition, a friction clutch mechanism including one or more friction plates may be employed instead of the second clutch mechanism 22.

Next, the guide rod 9 will be described.

As shown in FIGS. 17, 18, the guide rod 9 has a support shaft 60 and first and second engagement members 61, 62. The first and second engagement members 61, 62 are positioned with respect to the support shaft 60 by means of retaining rings 63. A guide portion 64 in which the chain 2 engages is formed between the first and second engagement members 61, 62 in the support shaft 60. The first engagement member 61 has a wide body 61a in circumference of the first disk 10A and an engagement portion 61b extending from the body 61a toward the first disk 10A, which is movable in the radial direction and non-rotationally engaged with the straight radial slit 14 of the first disk 10A.

The end face on the engagement portion 61b side of the body 61a has engagement teeth 61c that can engage and disengage with the rack teeth 14a on both sides of the straight radial slit 14. The second engagement member 62 has a wide body 62a in circumference of the first disk 10B and an engagement portion 62b extending from the body 62a toward the first disk 10B, which is movable in the radial direction and non-rotationally engaged with the straight radial slit 14 of the first disk 10B.

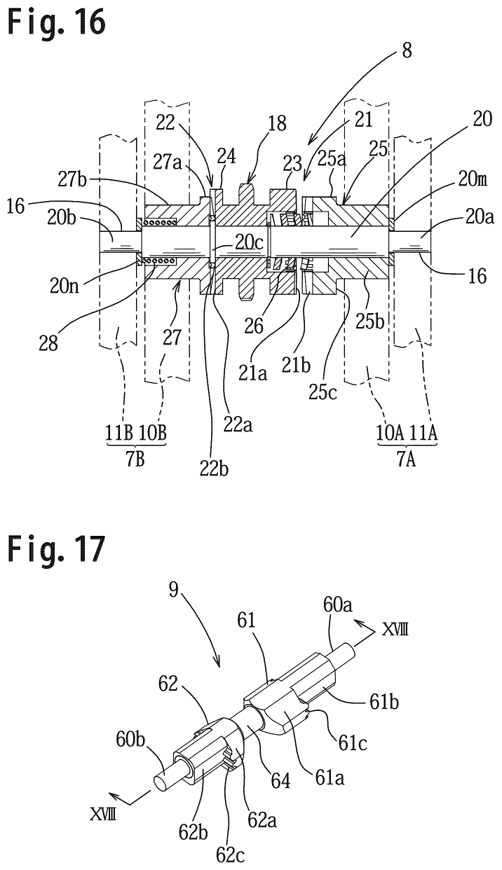

Slightly smaller diameter portions 60a, 60b are formed at both ends of the support shaft 60. The smaller diameter portion 60a is inserted into the curved radial slit 17 of the second disk 11A via washer 65a. The small diameter portion 60b is inserted into the curved radial slit 17 of the second disk 11B through the washer 65b. FIG. 18 shows a pair of first disks 10A, 10B separated from each other. As shown in FIG. 16, the end of the first clutch member 25 is held in a fixed position by the washer 20m and the second disk 11A. The end of the second clutch member 27 is held in a fixed position by the washer 20n and the second disk 11B.

As shown in FIG. 11, the end of the main shaft 6 is supported by the support column 4 via the bearing 5. Between the second disks 11A, 11B and the bearing 5, a washer 36a is attached to the main shaft 6, and the axial position of the second disks 11A, 11B is fixed.

When the first disk 10A is moved outward (in the direction of separation) by the disk moving mechanism 40A during speed change operation, the first clutch mechanism 21 is separated by the force of the first spring 26. When the first disk 10B is moved outward (in the direction of separation) by the disk moving mechanism 40B, the second clutch mechanism 22 is in a half-clutched state that can slip through the corrugated teeth, although the relatively weak force of the second spring 28 maintains a weak connection state.

Therefore, although sprockets 18 are allowed to rotate, the second spring 28 and the second clutch mechanism 22 exert a resistance to rotation, and when a rotation torque is exerted on sprockets 18, they rotate in response to that torque.

Next, actions and effects of the transmission mechanism 1A will be described.

When not in speed change operation (during normal operation), the first disks 10A, 10B are in the normal position with the first and second clutch mechanisms 21, 22 of the sprocket units 8 connected, so that the sprockets 18 are in a rotation-prohibited state. In this state, the rotational drive force transmitted from the driving force transmission chain 2 is transmitted to the first and second disk sets 7A, 7B via the four sprockets 18 and the four guide rods 9 to ensure that the first and second disks 10A, 10B, 11A. 11B are driven in rotation.

During this normal operation, the radial position of the sprockets 18 are fixed because the engaging teeth 25c, 27c of the locking mechanisms 29A, 29B on both sides of the sprocket 18 maintain engagement with the rack teeth 13a on both sides of the straight radial slit 13. Therefore, the sprockets 18 does not move in the radial direction, resulting in a stable operating condition. This is also the case for the four guide rods 9, where the engaging teeth 61c, 62c engage the rack teeth 14a to fix their radial position.

During speed change operation, both or any one of the clutch mechanisms 19m, 19n are disconnected, and connected at the end of speed change operation.

During speed change operation, when the first disks 10A, 10B are switched to the outside (detached position) by operating the disk moving mechanisms 40A, 40B, the first clutch mechanism 21 of the sprocket units 8 is switched to the disconnected state, the second clutch mechanism 22 maintains the half-clutched state, and the sprockets 18 can rotate. At the same time, the engagement teeth 25c, 27c of the locking mechanisms 29A, 29B disengage from the rack teeth 13a on both sides of the straight radial slits 13, and the engagement teeth 61c. 62c of the guide rods 9 disengage from the rack teeth 14a on both sides of the straight radial slits 14. Therefore, the sprocket units 8 and the guide rods 9 are movable in the radial direction.

In this state, when the main shaft 6 is moved to the left in FIG. 11 by the phase change mechanism 50, the second disks 11A, 1B rotate in the reverse direction relative to the disks 10A, 10B, and the radius of the composite sprocket S is switched to the reduced side. Then, the main shaft 6 is moved to the right in FIG. 11, the second disks 11A, 11B rotate in the forward direction, and the radius of the composite sprocket S is switched to the expanding side.

The transmission T is not a stepless transmission, but a stepped transmission that can be switched in multiple steps (e.g., about 60 steps), as described below.

The following is an explanation of considerations that must be taken into account when designing this transmission mechanism 1A.

When switching the radius of the composite sprocket S by the phase change mechanism 50, the radius must be set so that the sprockets 18 are in the same phase when the main shaft 6 makes one rotation with the chain 2 wound around it. In other words, the outer circumference length of one lap of the composite sprocket S must be an integer multiple of the link pitch of the chain 2. This is the case when the adjacent outer circumference length between adjacent sprockets (including guide rods) satisfies the following equation.

L: Length of adjacent outer circumference, P: Pitch of chain link, N: Number of sprockets 18, m: Integer, when the following L is satisfied, the sprockets 18 are in the same phase at one rotation of the composite sprocket S.

$$L = P * m + ( P / N ) * 0 \qquad ( 1 )$$

$$L = P * m + ( P / N ) * 1 \qquad ( 2 )$$

$$⋮ \qquad ⋮$$

$$L = P * m + ( P / N ) * ( N - 1 ) \qquad ( n )$$

If the number of sprockets 18 is four, as in this embodiment, it is as follows.

L=P*m+0*P (1a)

L=P*m+0.25*P (2a)

L=P*m+0.5*P (3a)

L=P*m+0.75*P (4a)

When the radius of the composite sprocket S is set so that only equation (1a) above is satisfied, the number of speed change steps is minimized. When the radius of the composite sprocket S is set to satisfy equation (2a) above, the number of speed change steps is maximized. Since the sprockets 18 can rotate during speed change operation, equations (1a) through (4a) above can all be employed.

The pitch of the rack teeth 13a and 14a should be set to match the speed change steps when (1a) through (4a) above are satisfied.

By the way, in the case of equation (1) above, no phase difference occurs between adjacent sprockets 18, but in cases other than equation (1), a phase difference occurs between adjacent sprockets 18.

The phase difference between adjacent sprockets 18 in association with equations (1) through (n) above can be determined as follows.

θ: phase difference between adjacent sprockets 18, A: number of teeth of sprocket 18, N: number of sprockets 18,

$$In the equation ( 1 ) , θ = ( 360 ° / A ) * 0 / N$$

$$In the equation ( 2 ) , θ = ( 360 ° / A ) * 1 / N$$

$$⋮$$

$$In the equation ( n ) , θ = ( 360 ° / A ) * ( N - 1 ) / N$$

If the number of sprockets 18 is 4 and the number of teeth A is 10, as in this embodiment, the following is obtained.

In the case of equation (1a), θ=0° (1b)

In the case of equation (2a), θ=9° (2b)

In the case of equation (3a), θ=18° (3b)

In the case of equation (4a), θ=27° (4b)

The phase difference between adjacent sprockets 18 must be absorbed through the dock clutch mechanisms 21, 22. Therefore, the pitch angle of the clutch teeth of the dog clutch mechanisms 21, 22 must be set to the same angle as the sprocket 18 in the case of equation (1b), 9° in the case of equation (2b), 18° in the case of equation (3b), and 27° in the case of equation (4b).

When setting the radius of the composite sprocket S when speed change operation is performed, the control unit CU sets the radius of the composite sprocket S based on the speed change command and a pre-set speed change map with the radius set as described above.

As described above, when the main shaft 6 makes one rotation with the chain 2 wound around it, the sprockets 18 are in the same phase, so there is no interference between the teeth of the sprockets 18 and the chain 2, resulting in smooth and quiet operation. At the end of the speed change operation, it is preferable to end the speed change operation in the state that the composite sprocket S should rotate at least about 1800 after the completion of the speed change operation.

When setting the radius of the composite sprocket S, sprockets 18 can be pulled into the phase such that the outer circumference length of the composite sprocket S is an integer multiple of the link pitch of chain 2 by the second clutch mechanism 22 in the half-clutched state as described above.

Moreover, since the tips of the teeth 18a of the sprockets 18 are pointed, interference between the teeth 18a of the sprockets 18 and the chain 2 does not occur.

Gear teeth 10a, 10b for drive force input or drive force output are formed on the outer circumference of at least one of the first disks 10A, 10B of the first and second disk sets 7A, 7B. Therefore, since no torsional load acts on the main shaft 6, the diameter of the main shaft 6 can be formed narrower, and the radius of the composite sprocket S when the composite sprocket S is set to the smallest diameter can be reduced to make the transmission mechanism 1A smaller.

### Second Embodiment

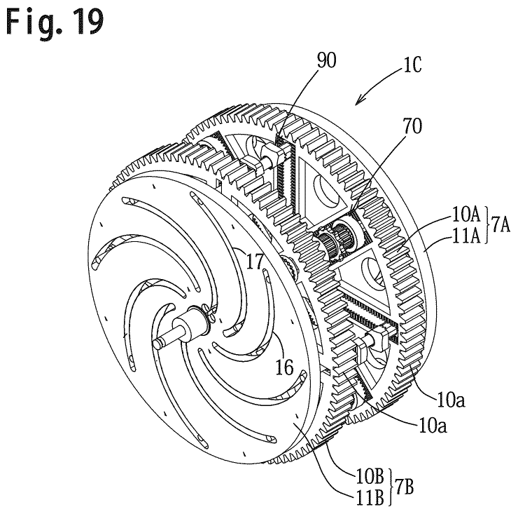

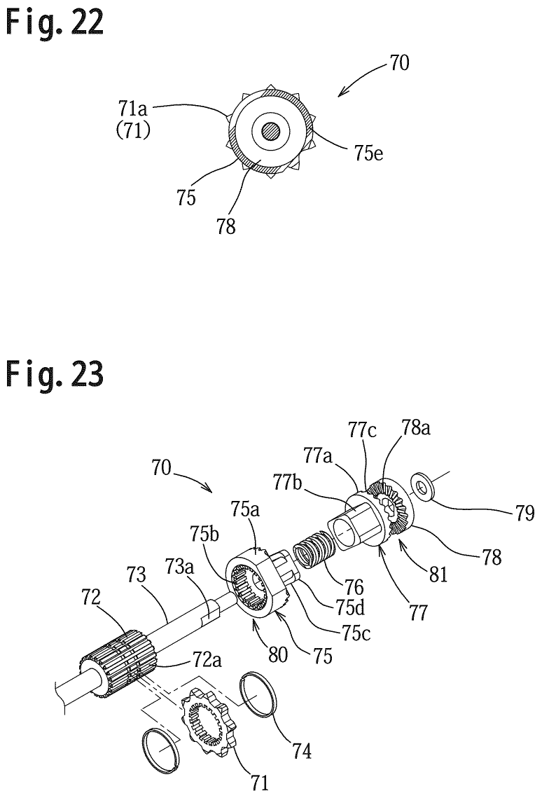

The second embodiment of the present invention will be described based on FIGS. 19 to 27.

A transmission mechanism 1C described below can be used in place of the transmission mechanisms 1A and 1B described above.

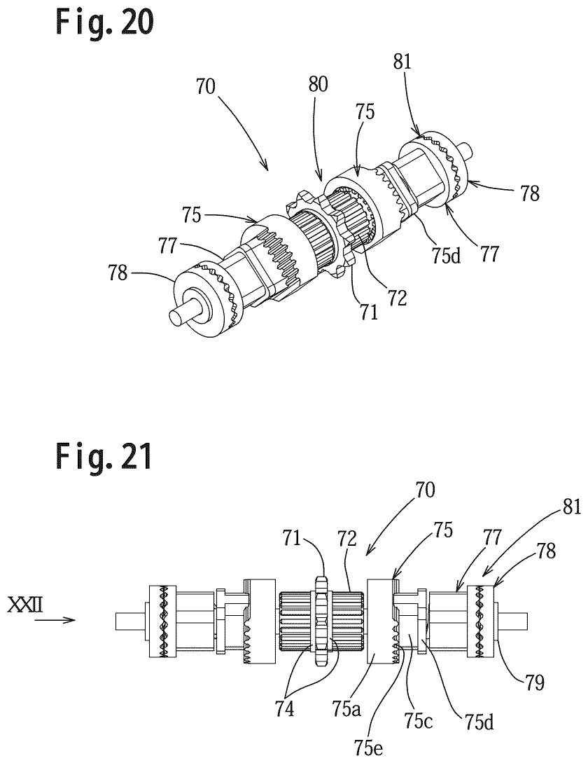

The main part of the transmission mechanism 1C is shown in FIG. 19. This transmission mechanism 1C uses a spline-coupled clutch mechanism for the clutch mechanism of sprocket units 70. The sprocket units 70 have a symmetrical structure in the axial direction across the sprocket 71 as shown in FIGS. 20 through 23, so the structure on one side will be described. The same reference numerals are used for the same configuration as in the first embodiment, and omit their description. The sprocket correspond to the transmission wheel, and the composite sprocket corresponds to the composite transmission wheel.

Sprocket unit 70 has a support shaft 73 with a spline shaft portion 72, a sprocket 71 spline-coupled to the spline shaft portion 72, a retaining ring 74 that regulates the position of the sprocket 71, a spline member 75, a compression spring 76, a clutch body 77, a clutch member 78 and washer 79, and so on. The clutch member 78 contacts the inner surface of the second disk 11A via a washer 79. The support shaft 73 inserts the spline member 75, the compression spring 76, the clutch body 77, and the clutch member 78.

The spline member 75 has a cup-shaped engagement portion 75a with spline teeth 75b on the inner surface of its recessed portion, a guide portion 75c with a rectangular cross section, and a rectangular flange 75d. The spline member 75 can be spline-coupled to the spline shaft portion 72, and the engagement portion 75a and the spline shaft portion 72 are configured to form a first clutch mechanism 80. In order to avoid interference between spline teeth 72a of the spline shaft portion 72 and the spline teeth 75b when connecting the first clutch mechanism 80, sharp edges may be formed at the tips of the spline teeth 72a, 75b.

The clutch body 77 has a disk portion 77a, a guide portion 77b of rectangular cross section protruding from the disk portion 77a toward the spline member 75, and clutch teeth 77c formed on the outer tip surface of the disk portion 77a. The clutch member 78 has clutch teeth 78a on the inner tip surface that engage the clutch teeth 77c. The clutch body 77, the clutch member 78 and the compression spring 76 comprise a second clutch mechanism 81. The clutch teeth 77c, 78a are formed as corrugated teeth with a corrugated shape in the lateral view.

As shown in FIG. 25, the first disk 10A consists of a disk body 10m and a split disk 10n that is fixed to the inner surface of the sprocket 71 side of the disk body 110m. The first disk 10A has four first radial slits 82 (first straight radial slits) that guide the sprocket units 70 in the radial direction and four first radial slits 83 (first straight radial slits) that guide the four guide rods 90 in a radial direction at 45° intervals.

First radial slit 82 is formed into a stepped slit by a narrow slit portion 82a formed on the split disk 10n and a wide slit portion 82b formed on the disk body 10m. The narrow slit portion 82a is narrower than the wide slit portion 82b. Rack teeth 13a are formed on the inner surface of the spline 71 side of the split disk 10n near both sides of the narrow slit portion 82a. The rack teeth 13a is a rectangular tooth with a pointed tip in lateral view.

The guide portion 75c of the spline member 75 is attached to the narrow slit portion 82a formed in the split disk 10n in a radially movable and non-rotatable manner. When assembling the first disk 10A, the guide portion 75c of the spline member 75 is penetrated into the narrow slit portion 82a, and then the split disk 10n is joined to the disk body 10m with the composite bolts.

The end faces of the engagement portion 75a of the spline member 75, on both sides of the guide portion 75c, have engagement teeth 75c that engage the rack teeth 13a on both sides near the narrow slit portion 82a. The flange 75d of the spline member 75 is mounted on the wide slit portion 82b in the radial direction movable and non-rotatable manner. The flange 75d cannot pass through the narrow slit portion 82a.

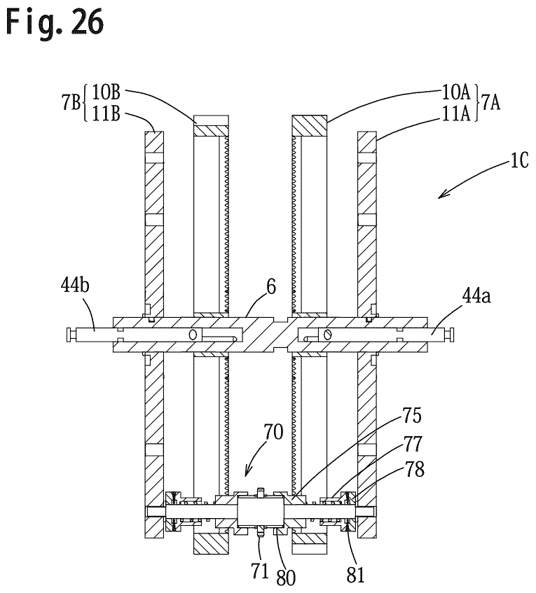

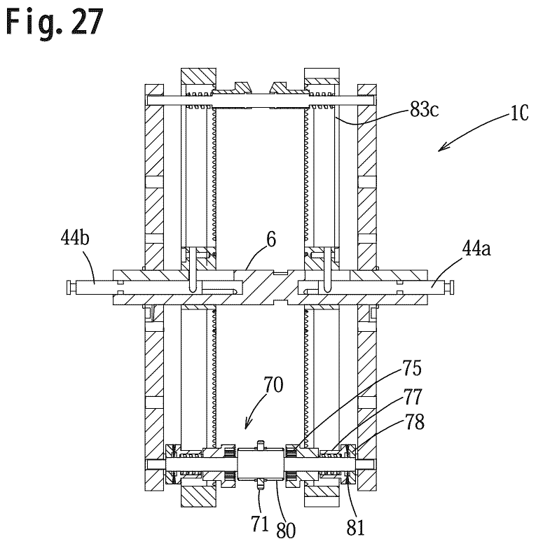

The first disk 10A can be switched to an approaching position shown in FIG. 26 and to a detached position shown in FIG. 27 by a mechanism similar to the disk moving mechanism 40A in the first embodiment. The first disk 10A is held in the approaching position when not in speed change operation (when in normal operation), and is switched to the detached position during speed change operation.

During normal operation, the first clutch mechanism 80 is maintained in a connected state by regulating the position of the spline member 75 by the first disk 10A to the position on the sprocket 71 side, and the engagement teeth 75e remain engaged with the rack teeth 13a. Therefore, the sprocket 71 does not move in the radial direction, and the spline member 75 is always maintained in a non-rotatable state.

During speed change operation, the first clutch mechanism 80 is switched to a disengaged state by switching the first disk 10A to a disengaged position, which is moved toward the second disk 11A, and pushing the spline member 75 by the flange 75d to the opposite side of the sprocket 71. In this state, the sprocket unit 70 can move radially along the first radial slits 82 because the engagement teeth 75e are separated from the rack teeth 13a.

The guide portion 77b of the clutch body 77 is attached to the wide slit portion 82b formed in the disk body 10m in a radial direction movable and non-rotatable manner. A D-cut portion 73a is formed on the tip of the support shaft 73, and this D-cut portion 73a is inserted into the clutch member 78, so that the support shaft 73 and the clutch member 78 rotate together. The spline member 75 and the clutch body 77 can rotate relative to the support shaft 73.

The compression spring 76 always forces the clutch body 77 toward the clutch member 78 while pushing the spline member 75 toward the sprocket 71 to keep the second clutch mechanism 81 connected. However, since the clutch teeth 77c, 78a of the second clutch mechanism 81 are corrugated teeth, the second clutch mechanism 81 is always in a half-clutched state. When the first clutch mechanism 80 is in the disconnected state, if a large torque acts on the sprockets 71, the clutch member 78 rotates with the support shaft 73, while the clutch body 77 does not rotate, thus causing slippage in the second clutch mechanism 81.

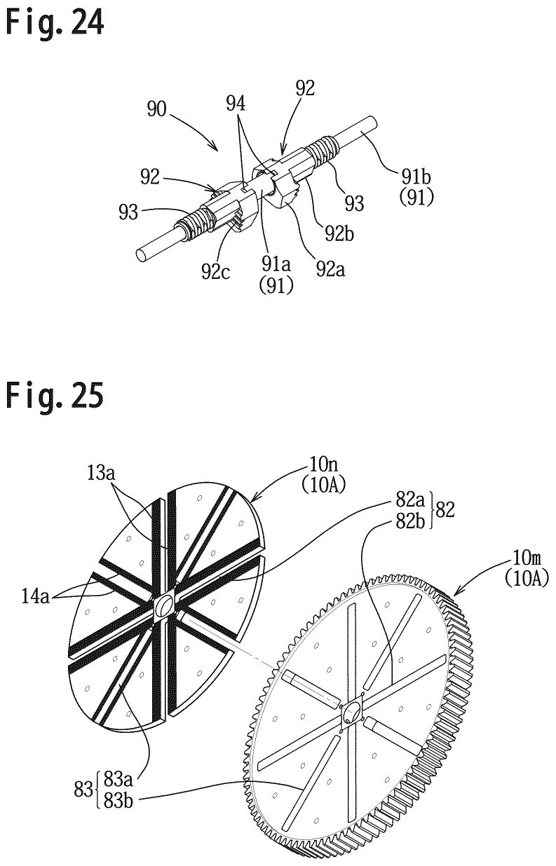

Next, the guide rod 90 will be described based on FIGS. 24, 27.

The guide rod 90 has a support axis 91 that includes a large diameter axis portion 91a and small diameter axis portions 91b, a pair of regulation members 92 that are externally fitted to the large diameter axis portion 91a of the support axis 91 and positioned by retaining rings 94, and compression springs 93 that forces these regulation members 92 inward (in a direction away from the first disk 10A).

The regulation member 92 has a regulation portion 92a, in which the engaging side of the chain protrudes toward the outer diameter with a sloping surface, and a guide portion 92b, which extends from the regulation portion 92a toward the outside in the axis direction. The end portions of the regulation portion 92a on both sides of the guide portion 92b have engagement teeth 92c that engage the rack teeth 14a on both sides of the first radial slit 83. The rack teeth 14a and engagement teeth 92c are rectangular gears with pointed tips in lateral view.

An engagement portion 91a in which the chain 2 engages is formed between the pair of regulation members 92, and the pair of regulation portions 92a protrude toward the outer diameter and guide the chain 2 toward the engagement portion 91a. The guide portion 92b is inserted into the first radial slit 83 in a radially movable and non-rotatable manner.

As shown in FIGS. 25, 27, the first radial slit 83 is formed into the stepped slit having wide slit portions 83a, 83b and narrow slit portion 83c, the narrow slit portion 83c being formed in the portion of the first disk 10A opposite the split disk 10n.

As shown in FIG. 27, when the first disk 10A is in the approaching position, the engagement teeth 92c engage the rack teeth 14a on both sides of the first radial slit 14. During speed change operation, the first disk 10A is switched to the detached position, so the engagement teeth 92c are separated from the rack teeth 14a.

The guide rod 90 is pushed toward the retaining rings 94 by the force of a pair of compression springs 93, and the engagement portion 91a is slightly narrower than the width of the chain 2. When the chain 2 engages the engagement portion 91a, the side portions of the chain 2 first contact the slopes of the pair of regulation members 92a, pushing the width of the engagement portion 91a wider as the chain 2 engages the portion 91a. Therefore, the collision noise when the chain 2 collides is reduced.

Next, the actions and effects of the transmission mechanism 1C above will be described.

Since this transmission mechanism 1C works in the same way as the transmission mechanism 1A above, it will be described briefly.

During speed change operation, the first clutch mechanism 80 is set to the state of disconnected, the second clutch mechanism 81 maintains the half-clutched state, and the sprocket unit 71 is allowed to rotate itself through the half-clutched state of the second clutch mechanism 81, and can move in the radial direction. In this state, the radius of the composite sprocket S can be changed to change the speed change ratio. Since the sprocket 71 is in the rotation permitted state, the phase of the sprocket 71 is securely adapted to the chain.

During other than speed change operation, the sprocket 71 is in the rotation prohibited state and is firmly unmovable in the radial direction. Therefore, the load torque transmitted from the chain 2 can be transmitted certainly, resulting in excellent transmission efficiency.

Next, various modifications to the above embodiments will be described.
(1) In the transmission mechanisms 1A, 1C, pinions may be employed in place of the sprockets 18, 71, and a toothed belt may be employed in place of the driving force transmission chain 2.
(2) The second clutch teeth 22a, 22b of the second clutch mechanism 22 may be omitted and instead one or more composite of friction surfaces may be formed that make frictional contact. In this case, the disk moving mechanism 40B and its accompanying mechanism may be omitted.

(3) When two sets of transmission mechanisms T including transmission mechanisms 1A and 1B are connected together, the individual transmission mechanisms 1A and 1B can be made smaller, resulting in a compact transmission system.
(4) In the sprocket unit 70, instead of corrugated clutch teeth of the second clutch mechanism 81, one or more composite friction surfaces may be provided.

One of the pair of first clutch mechanisms 80 in the sprocket unit 70 may be omitted. One of the pair of second clutch mechanisms 81 may also be omitted.
(5) The sprockets 18, 71 of the sprocket units 8, 70 may be arranged in parallel according to the transmission torque.
(6) The gear teeth 10a, 10b of the first disks 10A, 10B may be omitted, and the drive force may be input/output via a clutch mechanism to the main shaft 6.
(7) Either one of the clutch mechanisms 19m, 19n may be omitted.
(8) Synchromesh mechanisms may be employed for the first and second locking mechanisms 29A, 29B and clutch mechanisms 21, 22, 80, 81.
(5) Various other modifications can be made to the above embodiments by those skilled in the art, and the present invention includes such modifications.

### DESCRIPTION OF REFERENCE NUMERALS

T: transmission
S: composite sprocket
1A, 1B, 1C: transmission mechanism
2: driving force transmission chain
6: main shaft
7A, 7B: first and second disk sets
8: sprocket unit
9: guide rod
10A, 11A: first and second disks
10B, 11B: first and second disks
10a, 10b: gear teeth
13, 14: first radial slit
13a, 14a: first and second rack teeth
16, 17: second radial slit
18, 71: sprocket
19a, 19b: gear member
29A, 29B: first and second locking mechanisms
21, 22, 80, 81: clutch mechanism
40A, 40B: disk moving mechanism
50: phase change mechanism
80: spline coupling type clutch mechanism

1. A transmission mechanism comprising a main shaft, first and second disk sets mounted on the main shaft in a spaced apart and facing manner each having first and second disks mounted on the main shaft in close proximity perpendicular to the main shaft, a plurality of first and second radial slits formed in the first and second disks respectively, and a plurality of transmission wheels formed by a plurality of sprockets or pinions supported at intersections of the first and second radial slits in the first and second disk sets and a plurality of guide rods, and a composite transmission wheel for engaging with a driving force transmission chain or toothed belt is configured with the plurality of transmission wheels and the plurality of the guide rods;
wherein
each of transmission wheels is provided with at least one clutch mechanism capable of switching the transmission wheel between a rotation prohibited state and a rotation permitted state,
through the clutch mechanism, each transmission wheel is put in the rotation permitted state during speed change operation, and is put in the rotation prohibited state during other than speed change operation.

2. The transmission mechanism according to claim 1, further comprising a phase change mechanism capable of changing a rotation phase of the second disk with respect to the first disk in the first and second disk sets during speed change operation.

3. The transmission mechanism according to claim 2, further comprising a disk moving mechanism capable of moving at least one of the first disks on a side of the clutch mechanism of the first and second disk sets by a predetermined distance in a direction in which the transmission wheel is allowed to rotate.

4. The transmission mechanism according to claim 3, said at least one clutch mechanism includes first and second dog clutch mechanisms provided on both sides of the transmission wheel.

5. The transmission mechanism according to claim 4, one of the first and second dog clutch mechanisms is in a half-clutched state during speed change operation, and the transmission wheels are put in the rotation prohibited state during other than speed change operation.

6. The transmission mechanism according to claim 3, first rack teeth are formed near the first radial slits into which support shafts for supporting transmission wheels are inserted in the pair of the first disks of the first and second disk sets,
further comprising a first locking mechanism that locks the transmission wheels in cooperation with the first rack teeth so that the transmission wheels cannot move in a radial direction of the first disk during other than speed change operation, and allows the transmission wheels to move in the radial direction of the first disk during speed change operation.

7. The transmission mechanism according to claim 3, second rack teeth are formed near the first radial slits into which the guide rods are inserted in the pair of the first disks of the first and second disk sets,
further comprising a second locking mechanism that locks the guide rods in cooperation with the second rack teeth so that the guide rods cannot move in a radial direction during other than speed change operation, and allows the guide rods to move in the radial direction during speed change operation.

8. The transmission mechanism according to claim 1, gear teeth are formed on an outer circumference of the first disk of at least one disk set of the first and second disk sets, and a gear member for driving force input or driving force output that meshes with the gear teeth is provided.

9. The transmission mechanism according to claim 3, said at least one clutch mechanism includes first and second splined clutch mechanisms provided on opposite sides of the transmission wheel.

10. The transmission mechanism according to claim 2, the transmission wheel is the sprocket, and when changing the radius of the composite transmission wheel via the phase change mechanism during speed change operation, the radius is set so that an outer circumference length of the composite transmission wheel is an integral multiple of a link pitch of the driving force transmission chain.

11. The transmission mechanism according to claim 1, the transmission wheel is the sprocket, when setting the radius of the composite transmission wheel during speed change operation, the sprockets are set to a sprocket phase such that the outer circumference length of the composite transmission wheel is an integral multiple of a link pitch of the driving force transmission chain and the sprockets are put in the rotation prohibited state.

12. The transmission mechanism according to claim 5, the transmission wheel is the sprocket, when setting the radius of the composite transmission wheel during speed change operation, the clutch mechanism which is in a half-clutched state, makes the sprockets to have a phase such that the outer circumference length of the composite transmission wheel is an integral multiple of a link pitch of the driving force transmission chain.
